(19) United States
(12) Patent Application Publication
(10) Pub. No.: US 2012/0299356 A1
(43) Pub. Date: Nov. 29, 2012

(54) Headrest apparatus

(76) Inventor: Matt Edwards, St. Louis, MO (US)

(21) Appl. No.: 13/134,084

(22) Filed: May 27, 2011

(51) Int. Cl. B60N 2/48; A47C 7/38

(52) U.S. Cl. 297/397; 297/391

(57) ABSTRACT

A headrest apparatus for engagement to an existing vehicle headrest and configurable to one of a plurality of configurations and orientations is disclosed. The headrest apparatus includes a back support member having first and second connectors configured to engage first and second side elements, respectively. The first and second side elements each include a side portion for providing a headrest area configured to provide a headrest area for an individual's head and a neck portion configured to engage the first and second side elements to either the first or second connector at different orientations.

### FIELD

This document relates to a headrest apparatus, and in particular to a headrest apparatus configured to be engaged to an existing vehicle headrest.

### BACKGROUND

Removable headrests for engaging an existing vehicle headrest are well known. These types of headrests may support the neck or provide structural side elements for supporting an individual's head during rest. Although these types of removable headrests function well for their intended purpose, such removable headrests have one type of configuration that does not allow an individual to configure the headrest in various arrangements and orientations. In addition, such removable headrests may be incapable of supporting a person's body weight.

### SUMMARY

In one embodiment, a headrest apparatus may include a back support member having a body defining a rear surface and a front surface. The body forms a first connector and a second connector. In addition, the headrest apparatus includes a first side element including a first side portion and a first neck portion configured to engage the first connector in a substantially transverse orientation relative to the front surface of the back support member wherein the first side element is configured to swivel at different orientations.

In another embodiment, a method of using a headrest apparatus may include:
providing a headrest apparatus comprising:
   a back support member having a body defining a rear surface and a front surface, the body forming a first connector and a second connector, the body further including at least one strap and at least one securing strip each secured to the back support member;
wrapping the at least one strap around an existing vehicle headrest and engaging the at least one strap to the securing strip; and
engaging at least one of a first side element or a second side element to the first connector or second connector, respectively, such that the first side element and the second side element extend outwardly from the front surface at a substantially transverse orientation relative to the front surface.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a top view of a headrest apparatus showing a back support element engaged to first and second side elements;

FIG. 2 is a front view of the headrest apparatus showing the swiveling action of the first side element;

FIG. 3 is a rear view of the headrest apparatus showing the swiveling action of the second side element;

FIG. 4 is a front view of the back support member;

FIG. 5 is a rear view of the back support member;

FIG. 6 is a top view of the back support member;

FIG. 7 is a perspective view of the first support element;

FIG. 8 is another perspective view of the first support element;

FIG. 9 is an end view of the first support element;

FIG. 10 is an opposite end view of the first support element;

FIG. 11 is a side view of the first support element;

FIG. 12 is an opposite side view of the first support element;

FIG. 13 is a front view of the first support element illustrating the underlying layers;

FIG. 14 is a rear view of the first support element; and

FIGS. 15 and 16 are perspective views of the headrest apparatus illustrating the method of engaging the headrest apparatus to an existing vehicle headrest.

Corresponding reference characters indicate corresponding elements among the various views of the drawings. The headings used in the figures should not be interpreted to limit the scope of the claims.

### DETAILED DESCRIPTION

As described herein, a headrest apparatus and method of engaging such a headrest apparatus to an existing vehicle headrest in which the headrest apparatus may be configured in different arrangements is illustrated and described herein.

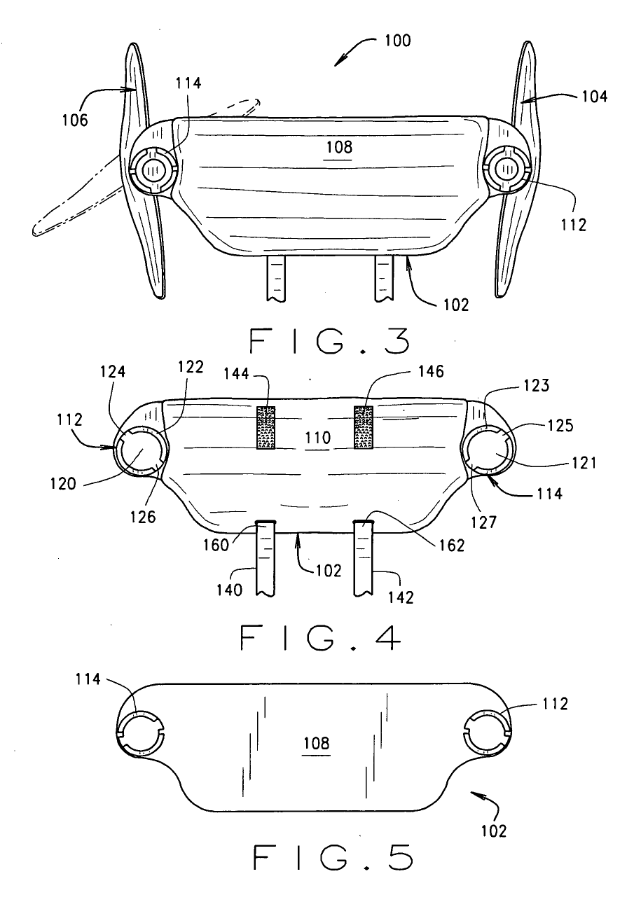

An embodiment of the headrest apparatus is shown and generally designated as 100 in FIGS. 1-3. Referring to FIG. 1, in general the headrest apparatus 100 includes a back support member 102 defining a rear surface 108 and a front surface 110 in which the back support member 102 is configured to engage a first side element 104 and/or a second side element 106. In one aspect, the first side element 104 and second side element 106 are engaged to the back support member 102 in a substantially transverse orientation relative to the front surface 110 of the back support member 102. In addition, the first side element 104 and the second side element 106 are configured to swivel in a plurality of orientations as shall be discussed in greater detail below.

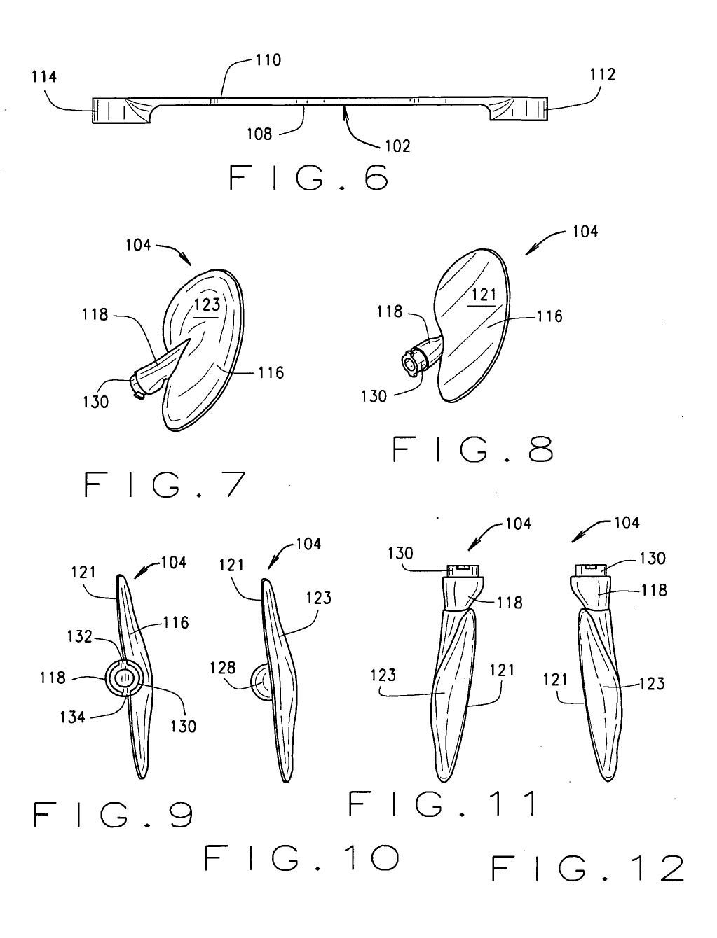

Referring to FIGS. 4-6, the back support member 102 defines a first female connector 112 and a second female connector 114 configured to engage the first side element 104 or the second side element 106, respectively. The first female connector 112 defines an aperture 120 in communication with a raised shoulder 122 that forms a first slot 124 and an opposing second slot 126. Similarly, the second female connector 114 defines an aperture 121 in communication with a raised shoulder 123 that forms a first slot 125 and an opposing second slot 127. In some embodiments, the first female connector 112 and the second female connector 114 have substantially the same structure and provide the substantially the same function to engage either the first side element 104 or second side element 106 to the back support member 102.

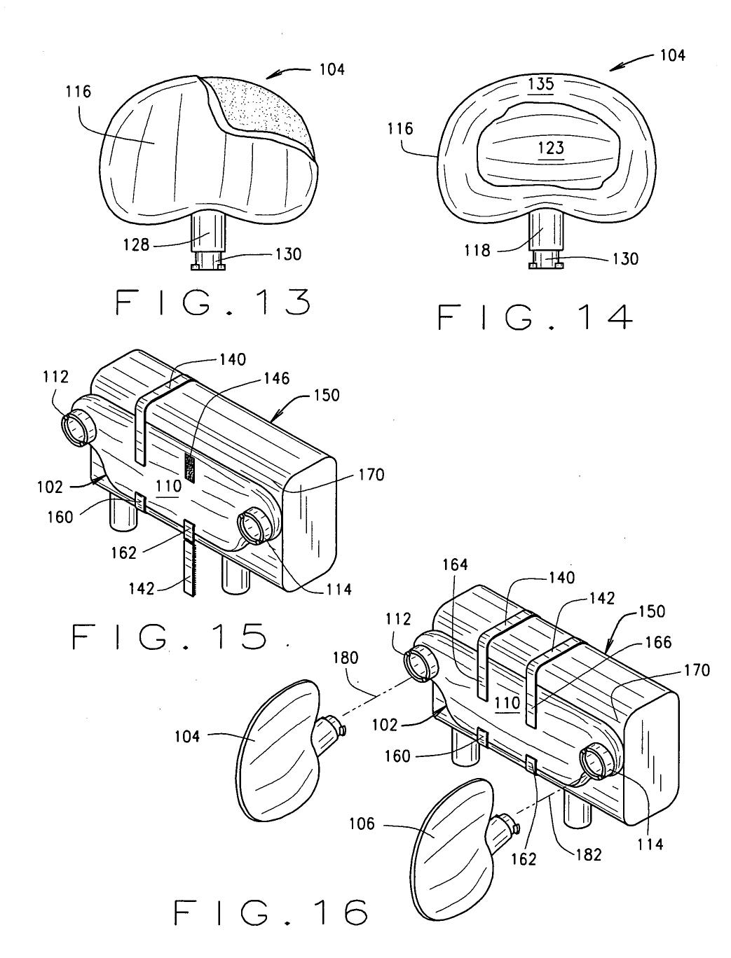

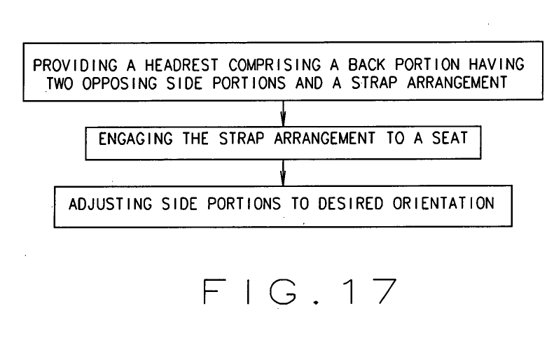

For the purpose of simplicity, the description of the first side element 104 and second side element 106 will be limited to describing solely the first side element 104 since both the first and second side elements 104 and 106 are identical in structure and function. Referring to FIGS. 7-14, an embodiment of the first side element 104 includes a side portion 116 configured to act as a headrest for an individual and a neck portion 118 that extends from the side portion 116 and is configured to engage either the first connector 112 and the second connector 106 of the back support member 102. The side portion 116 defines a first surface 121 configured to provide a headrest area and an opposing rear surface 123. In some embodiments, the side portion 116 may engage a soft, flexible cover 135 that covers the front surface 121 and most of the rear surface 123. For example, the cover 135 may be made from fur, wool, cotton, plush cotton material, pliable plastic material, rubber material, synthetic material, or any combination thereof that provides a comfortable headrest area for an individual.

A further shown, the neck portion 118 includes a male connector 130 configured to engage the first side element 104 to either the first female connector 112 or the second female connector 114 of the back support member 102. In one embodiment, the male connector 130 includes a first protrusion 132 and an opposing second protrusion 134 configured to engage either the first slot 124 or the second slot 126, respectively, of the first female connector 112 or either the first slot 125 and second slot 127, respectively, of the second female connector 114. In one example, once the first and second protrusions 132 and 134 are aligned with the first and second slots 124 and 126, the first and second protrusions 132 and 134 are rotated to one of a plurality of preset positions within the first female connector 112 that orients the side portion 116 to one of a plurality of different orientations. In some embodiments, engagement of the male connector 130 to either the first or second female connectors 112 and 114 allows the first side element 104 to swivel after engagement, and therefore permits the headrest apparatus 100 to adjust in response to the movement of the individual's head on the headrest area. In other embodiments, the engagement of the male connector 130 to either the first or second female connectors 112 and 114 allows the first side element 104 to be set in one or more preset positions with no swivel action once the first side element 104 is set to a particular preset position.

In some embodiments, the headrest apparatus 100 may be configured to have only one side element 104 or 106 engaged to either the first or second female connectors 112 and 114 of the back support member 102 in a single side element arrangement, while in other embodiments the headrest apparatus 100 may be configured to have both the first and second side elements 104 and 106 engaged to the first and second female connectors 112 and 114, respectively, in a dual side element arrangement.

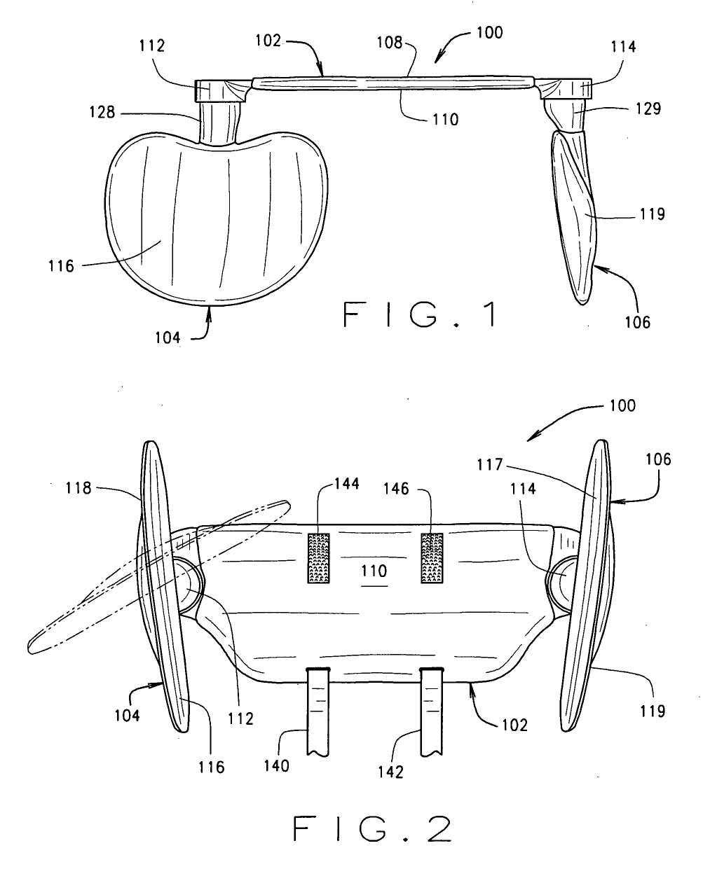

Referring to FIGS. 2, 4,15 and 16, the back support member 102 includes a first elongated strap 140 having a first end 160 secured to the front surface 110 of the back support member 102 and a second elongated strap 142 having a first end 162 also secured to another portion of the front surface 110. In addition, the first elongated strap 140 includes a second end 160 arranged to be engaged to a first securing strip 144 secured along the front surface 110 of the back support member 102, while the second elongated strap 142 includes a second end 162 engaged to a second securing strip 146 also secured along the front surface 110. In one embodiment, the first and second securing strips 144 and 146 as well as the first and second ends 164 and 166 of the first and second straps 140 and 142, respectively, may each include a VELCRO® material that allows the first and second ends 164 and 166 to be secured to the first and second securing strips 144 and 146. In other embodiments, other types of connecting arrangements may be utilized, such as a buckle arrangement. The first strap 140 and the second strap 142 are used to secure the back support member 102 to an existing vehicle headrest 150 as illustrated in FIGS. 15 and 16.

Referring to FIG. 15, the headrest apparatus 100 is engaged to an existing vehicle headrest 150 by placing the rear surface 108 of the back support member 102 in contact with the front surface 170 of the vehicle headrest 150. Once the back support member 102 is in contact with the existing vehicle headrest 150, the first elongated strap 140 and the second elongated strap 142 are wrapped under and around the existing vehicle headrest 150 such that the first and second ends 164 and 166 are engaged to the first and second securing strips 144 and 146, respectively, to secure the back support member 102 to the existing vehicle headrest 150. Referring to FIG. 16, after the back support member 102 is secured to the vehicle headrest 150, either the first side element 104 and/or second side element 106 are aligned along respective axes 180 and 182 and then engaged to the first and second female connectors 112 and 114 in the single or dual side element arrangement of the headrest apparatus 100.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A headrest apparatus comprising:
a back support member having a body defining a rear surface and a front surface, the body forming a first connector and a second connector;
a first side element including a first side portion and a first neck portion configured to engage the first connector in a substantially transverse orientation relative to the front surface of the back support member,
wherein the first side element is configured to swivel at different orientations.

2. The headrest apparatus of claim 1, wherein the headrest apparatus comprises a second side element including a second side portion and a second neck portion configured to engage the second connector in a substantially transverse orientation relative to the front surface of the back support member, wherein the second side element is configured to swivel at different orientations.

3. The headrest apparatus of claim 1, wherein the first neck portion and the second neck portion form respective one or more protrusions configured to engage a respective one or more slots defined by the first connector and the second connector, respectively.

4. The headrest apparatus of claim 1, wherein the first side portion and the second side portion are configured to have an oval-shaped configuration, a clover leaf-shaped configuration, a heart-shaped configuration, a square-shaped configuration, a rectangular-shaped configuration, or a circular-shaped configuration, respectively.

5. The headrest apparatus of claim 1, wherein the back support member comprises at least one strap configured to engage at least one securing strip for securing the headrest apparatus to an existing vehicle headrest.

6. The headrest apparatus of claim 1, wherein the first side element and the second side element are secured to the first connector or second connector, respectively, in a set orientation.

7. The headrest apparatus of claim 1, wherein the first side element and the second side element are secured to the first connector or the second connector, respectively, in a swiveling action.

8. The headrest apparatus of claim 1, wherein the first side element and the second side element are secured to the first connector or the second connector, respectively, such that either the first side element or the second side element is oriented at one of a plurality of preset positions.

9. The headrest apparatus of claim 8, wherein the first connector and the second connector each define at least one slot and the first side element and the second side element each define at least one protrusion configured to engage the at least one slot.

10. The headrest apparatus of claim 1′, wherein the first side element and the second side element each comprise an outer layer portion engaged to an inner layer portion, wherein the outer layer portion is configured to provide a soft surface area to rest an individual's head.

11. The headrest apparatus of claim 10, wherein the soft surface area comprises at least a fur material, a velvet material, a cotton material, a plush cotton material, a sponge material, a wool material, a rubber material, or a plastic material.

12. A method of using a headrest apparatus comprising:
providing a headrest apparatus comprising:
a back support member having a body defining a rear surface and a front surface, the body forming a first connector and a second connector, the body further including at least one strap and at least one securing strip each secured to the back support member;
wrapping the at least one strap around an existing vehicle headrest and engaging the at least one strap to the securing strip; and
engaging at least one of a first side element or a second side element to the first connector or second connector, respectively, such that the first side element and the second side element extend outwardly from the front surface at a substantially transverse orientation relative to the front surface.

13. The method of claim 12, further comprises positioning the at least one of the first side element or second side element to one of a plurality of different orientations.

14. The method of claim 12, wherein the at least one strap defines a first end secured to the front surface of the back support member and a second end configured to be engaged to the securing strip.

15. The method of claim 12, wherein the first side element and second side element each forms a side portion that provides a headrest area for a head of an individual and a neck portion configured to define one or more protrusions, and wherein the first connector and the second connector each define one or more slots configured to engage the one or more protrusions when engaging either the first side element or second side element to the back support member.
